(19) United States
(12) Patent Application Publication
(10) Pub. No.: US 2002/0116328 A1
(43) Pub. Date: Aug. 22, 2002

(54) Automotive finance portal

(76) Inventors: Alan Bird, Pickering (CA); Michael Collins, Toronto (CA); Kreig Smith, Overland Park, KS (US); Desmond Reynolds, Burlington (CA); Trevor Burgess, Burlington (CA); Joseph Lapenna, Hamilton (CA); Peter Gouvis, Woodbridge (CA); Gord Coker, Georgetown (CA)

Correspondence Address: NORRIS, McLAUGHLIN & MARCUS, 220 EAST 42ND STREET - 30TH FLOOR, NEW YORK, NY, 10017, US

(21) Appl. No.: 10/062,033

(22) Filed: Jan. 31, 2002

(30) Foreign Application Priority Data
Jan. 31, 2001 (CA) 2,333,342

(51) Int. Cl. G06F 17/60

(52) U.S. Cl. 705/38

(57) ABSTRACT

A method of processing an automotive finance transaction online by a portal participant including the steps of inputting business rules and rates for financial institutions into a database; entering criteria of chosen vehicle into a finance quotation generator; selecting a financial institution; generating a comparative quote scheme for the chosen vehicle according to the business rules and rates; and selecting a set of terms from the comparative quote scheme. The method may further include transmitting the selected set of terms to the financial institution; providing credit information to the financial institution; the financial institution evaluating the credit information and providing approval; and preparing financing documentation incorporating the vehicle information, terms and credit information. Furthermore, a system for processing an automotive financing transaction by a dealer or manufacturer is provided.

### FIELD OF THE INVENTION

The present invention relates to automotive financing systems. In particular, the present invention relates to an online portal system for automotive financing.

### BACKGROUND OF THE INVENTION

Car dealerships and manufacturers have been working to shorten the time it takes to deliver a vehicle to a customer from the time that the decision is made to acquire the vehicle until the customer takes possession. However, there is one area in which the time requirement has not been successfully reduced—shopping for finance options.

Customers must currently spend considerable time comparison shopping for finance options. Customers seeking finance options have not been able to go to one source to obtain comparable quotes on the same vehicle for the same type of finance contracts. They have not been able to compare item to item the different options for financing a given vehicle.

Another area of time delay for customers is at the credit approval stage. Customers have traditionally had to complete hand written credit applications for their chosen financial institution and then wait up to several days while the application data is entered into the credit processing systems, adjudicated, approved, and documents are prepared for signature. As adjudication and approval are done by human agents, the process is dependent on business hours and the limits of human efficiency.

There are also information access and integrity problems for dealers offering financing. Dealers must exercise great care when quoting customers financing options as the data has not always been current and up to date. As more dealerships adopt their own computerized systems, paper information sources must be manually input into each system to process customer quotes. Manual input of rates naturally incorporates human errors.

### SUMMARY OF THE INVENTION

According to a first aspect of the invention, a method of processing an automotive finance transaction online by a portal participant is provided. The method comprises the steps of:

(i) inputting business rules and rates for a plurality of financial institutions into an online database;

(ii) entering criteria of chosen vehicle into an online automotive finance quotation generator;

(iii) selecting a financial institution;

(iv) generating a comparative quote scheme for the chosen vehicle according to the financial institution business rules and rates; and

(v) selecting a set of terms from the comparative quote scheme.

Preferably, the method further comprises the steps of:

(vi) transmitting the selected set of terms to the selected financial institution;

(vii) providing credit information to the selected financial institution;

(viii) the financial institution evaluating the credit information and providing approval; and

(ix) preparing financing documentation incorporating the vehicle information, terms and credit information.

According to a second aspect of the invention, a system for processing an automotive financing transaction by a dealer or manufacturer is provided.

As used herein, “automotive financing transaction” refers to the process of negotiation, approval and settlement of terms for automotive financing of a particular selected vehicle, and any part of this process. “Portal participant” refers to car dealers, manufacturers and financial institutions that are members of the portal. Through the dealers and manufacturers, the portal also indirectly serves the end consumer of the vehicle.

### BRIEF DESCRIPTION OF THE FIGURES

FIG. 1 is a flow diagram according to an embodiment of the method.

FIG. 2 is a screen diagram of a vehicle selection window generated according to an embodiment of the method.

FIG. 3 is a screen diagram of a quoter window generated according to an embodiment of the method.

FIG. 4 is a screen diagram of a check list window generated according to an embodiment of the method.

### DETAILED DESCRIPTION OF THE PREFERRED EMBODIMENTS

The Internet is increasingly used in many industries to deliver real time services to customers and to provide efficient communication links between businesses. By bringing automotive suppliers (dealers and manufacturers) together with financial institutions (the sources of vehicle funding) through an Internet application, the time required to obtain vehicle financing by the customer can be greatly reduced. Efficiencies generated by Internet transaction processing also increase dealership productivity and decrease the financial institutions processing costs.

Online data collection software can be used through an Internet portal in direct interface with the credit processing systems of the financial institutions to produce the financing documentation for customers of automobile dealerships and manufacturers. Ideally, the system is available 24 hours per day adding convenience for portal users.

There are several areas of time saving by using an online automotive finance portal, such as the Curomax online automotive finance portal, 360Funding.com. First, credit applications may be submitted 24 hours per day, 7 days per week. Normal applications may be processed automatically according to the financial institution's standards for approval, and the system allows decision reporting within minutes. In the past, submission (including manual data entry) and reporting by fax required at least 1 to 2 hours.

Other time savings are realized by the re-use of data input directly from the customer to generate financing and insurance documents.

Finally, there is a hidden time savings in the reduction of human data entry errors (for example, interest rate, term, serial number) which would cause a generated contract to be invalid, needing re-generation and re-signature.

Membership in the portal is achieved by dealers, manufacturers and financial institutions signing on as members with the portal provider. Such enrollment may be done electronically over the portal itself, or may be done through a recruiting agent of the portal provider. Preferably, dealerships will be enrolled together with financial institutions according to existing funding relationships.

Turning to a preferred method, the portal provider will first input business rules supplied by the member financial institutions. Member financial institutions will advise the portal provider of their policy and criteria for their automotive finance programs. The portal provider will then incorporate these “business rules” into the portal system logic engine in one or more databases. Examples of business rule information include rules on advances, rules on residual and enhancements if any, terms available for different model years under different finance programs, document requirements, and customer identification requirements.

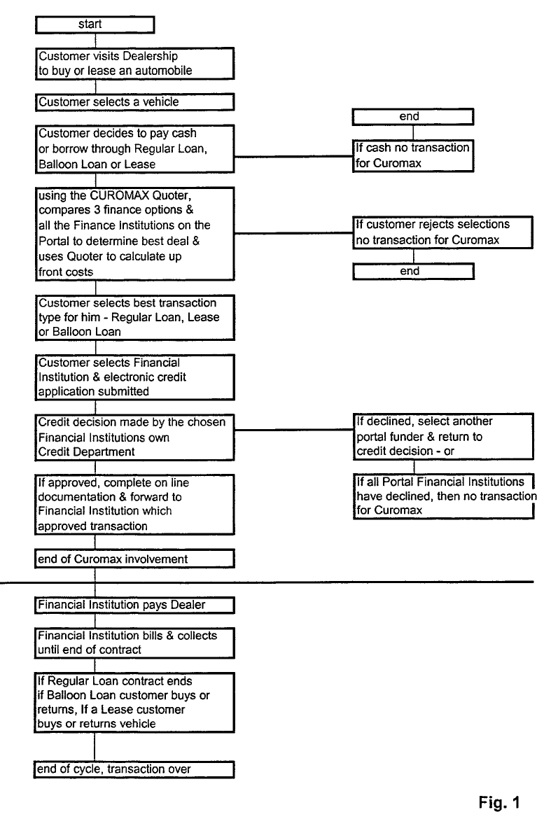

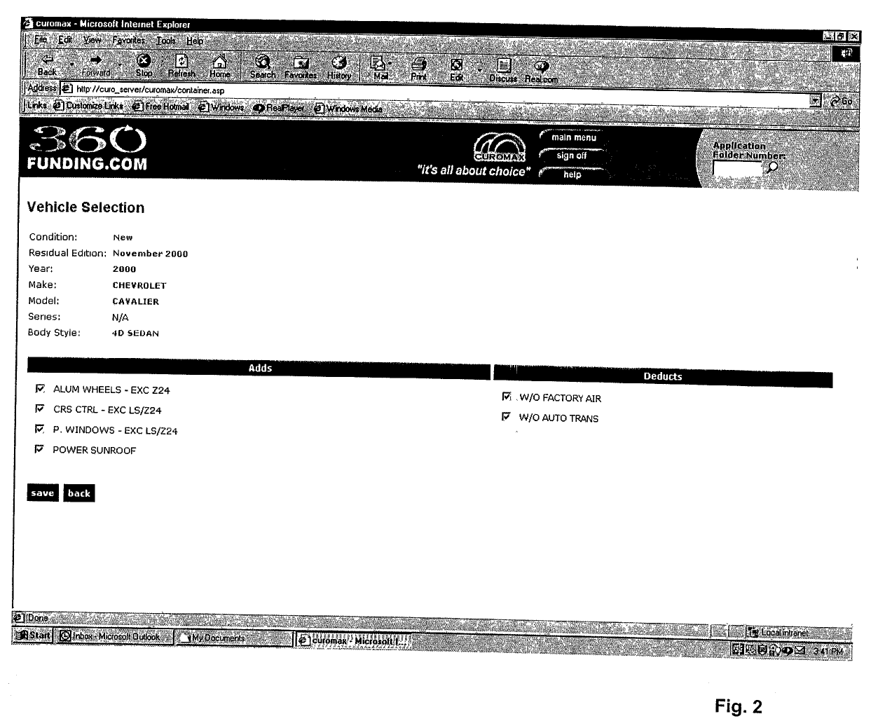

According to the preferred method shown in FIG. 1, at the beginning of every transaction, a vehicle is selected by going through a process that identifies all the criteria of the chosen vehicle to ensure that the proper description, options, advance against value and residual information are gathered. This information is used in the calculation of the loan or lease payments, description of the vehicle for the finance contract, and confirmation that the vehicle will meet the lending criteria set in the different programs by the Financial Institutions using the portal. Examples of the vehicle information include the condition, year, make, model, series and body style of the vehicle. An example of preferred vehicle selection criteria is shown in the Vehicle Selection screen at FIG. 2.

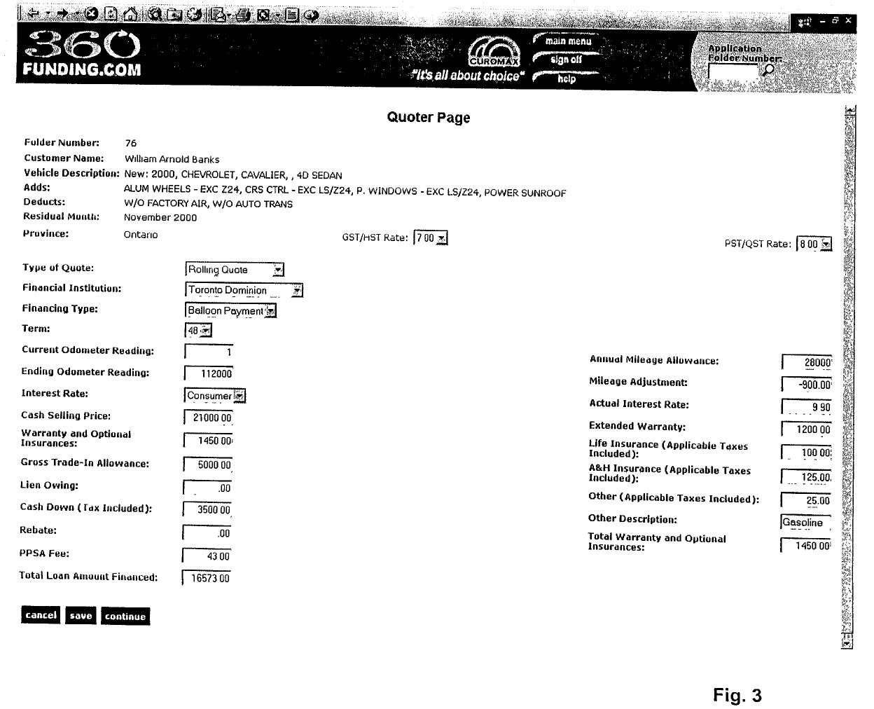

The customer can then select financing terms on which to base a quote for the selected vehicle. The Quoting tool in the portal uses the gathered information on the selected vehicle plus the business rules input on behalf of the Financial Institutions to produce comparative quotes based on the selected options in the array of interest rates and terms available for each vehicle selected. For example, the quoting tool may be used to compare loan, balloon loan and lease terms for a selected vehicle. An example of the preferred quote variables is indicated at FIG. 3.

Quotes include all applicable taxes for the selected vehicle. For example, Canadian federal and provincial tax rates are calculated automatically based on the customer's residence address. In Canada, different provincial tax rates apply for each province. In addition, certain provinces calculate provincial and federal taxes concurrently on the taxable price of the vehicle (as a harmonized sales tax (HST)), while other provinces apply the provincial sales tax on the compounded taxable price with federal tax already applied. The system takes these rules into account for each transaction, according to the residence of the customer.

Upon customer acceptance of a quote, the customer's credit information can be input at the dealership, and an online credit application can be submitted to a selected Financial Institution. The system's automated processing allows the application to receive financing approval within one minute. The online credit component is available 24 hours every day. If approval is not received automatically, the credit application can be resubmitted to another Financial Institution, or the application can be set aside for manual processing.

The Document generating portion uses the information obtained on the vehicle in the selection process, plus the numbers calculated in the quotation and the customer information from the credit application to produce a binding legal contract for a loan or lease for the Financial Institution which approved the contract. The generated contract preferably applies the proper financing document format for the jurisdiction of the customers residence, and applies the proper tax rates and calculation rules for that jurisdiction.

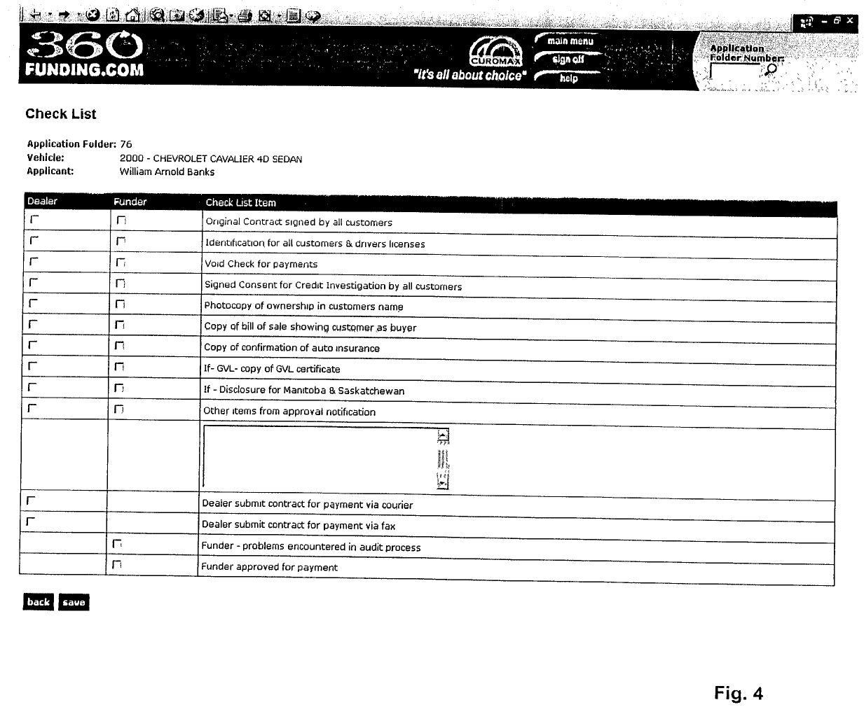

Through the system, dealers can notify the Financial Institution when they require funding on any completed application. The system allows the Dealers and the Funders to coordinate activities on particular customer accounts using an interactive screen, such as the sample Check List activity screen shown at FIG. 4. Funding documents may be sent electronically between the participants. Where electronic signature technology is adopted and recognized, financing documents can be finalized entirely online and copies printed by both the dealer and funder as needed.

From the data input by the dealer, Loan Contracts and related documents required by the Institution can be produced by the system. For example, the Financial Institution may require the system to produce a Loan Contract and Guaranteed Value Loan Certificate.

Turning to the system architecture and features, the system preferably comprises a conventional client-server network architecture, wherein all participants are clients to a server containing the processing intelligence and data storage for the system. The system makes use of Internet technology to receive and transmit financing information between the clients and server.

The system preferably employs conventional database structures for storage of inputted dynamic data, such as vehicle information and customer credit information, as well as, pre-entered static data, such as tax rates and Financial Institution business rules. The databases are preferably relational databases, which may be queried by a standard query language, such as Microsoft SQL.

System stability is essential for a 24-hour service. Therefore, the system is preferably fully redundant with full fail-over capabilities.

Data reliability is preferably ensured by the use of unique key constraints and user profiles for Dealers. Validation is preferably implemented through system validity checks for the vehicle identification number (VIN), customer social insurance number (SIN) and postal code/province.

Data security is preferably enhanced by the use of industry standard encryption standards. The system preferably incorporates SSL (Secure Socket Layer) technology using 128 BIT encryption for Internet transmissions.

It will be appreciated that the above description relates to the preferred embodiments by way of example only. Many variations on the apparatus for delivering the invention will be obvious to those knowledgeable in the field, and such obvious variations are within the scope of the invention as described and claimed, whether or not expressly described.

All patents, patent applications, and publications referred to in this paper are incorporated by reference in their entirety.

What is claimed is:

1. A method of processing a motor vehicle finance transaction online for a portal participant acting for a customer, the method comprising:
(a) receiving criteria of a chosen vehicle into an online automotive finance transaction engine;
(b) receiving a selection of a financial institution into the transaction engine;
(c) the transaction engine querying at least one database of business rules and rates input for the selected financial institution; and
(d) the transaction engine determining and displaying a comparative quote scheme for the chosen vehicle according to the selected financial institution business rules and rates, the comparative quote scheme comprising a plurality of sets of financing terms.

2. The method of claim 1, wherein the portal participant is selected from the group consisting of a motor vehicle dealer, a manufacturer, and a financial institution.

3. The method of claim 1, wherein the criteria is selected from the group consisting of make, model, year, series, body style, condition, additional features, and/or deducted features.

4. The method of claim 1, wherein step (a) further comprises receiving a vehicle identification number, the transaction engine checking the vehicle identification number against a database of known vehicle identification numbers to authenticate the transaction before proceeding to the next step.

5. The method of claim 1, wherein the business rules comprise rules on advances, rules on residuals and enhancements, terms for various model years, document requirements, and/or customer identification requirements.

6. The method of claim 1, wherein each set of financing terms comprises a finance option selected from the group consisting of a loan, a balloon loan, and a lease option.

7. The method of claim 1, wherein the rate comprises a lending rate associated with vehicle criteria according to a set of financing terms.

8. The method of claim 1, wherein the method further comprises the transaction engine calculating and displaying the taxes applicable to each set of financing terms.

9. The method of claim 8, wherein the method further comprises retrieving customer residence information into the transaction engine, the transaction engine querying a database of tax information corresponding to residence information, and the transaction engine calculating the taxes for each set of financing terms based on customer residence information.

10. The method of claim 1, wherein the method further comprises:
(e) receiving a selection of a set of financing terms from the comparative quote scheme into the transaction engine.

11. The method of claim 10, wherein the method further comprises:
(f) the transaction engine transmitting the selected set of financing terms to the selected financial institution;
(g) the transaction engine receiving and transmitting customer credit information to the selected financial institution as a credit application;
(h) the transaction engine receiving from the financial institution a signal indicating whether the financial institution has approved the credit application; and
(i) the transaction engine preparing financing documentation incorporating the criteria, selected set of financing terms, and customer credit information.

12. The method of claim 11 wherein the documentation comprises a loan contract and a guaranteed value loan certification.

13. A method of processing a motor vehicle finance transaction online for a portal participant acting for a customer, the method comprising:
(a) receiving criteria of a chosen vehicle into an online automotive finance transaction engine;
(b) receiving a selection of a financing option into the transaction engine;
(c) the transaction engine querying at least one database of business rules and rates input for a plurality of financial institutions; and
(d) the transaction engine determining and displaying a comparative quote scheme for the chosen vehicle according to the selected financing option, the comparative quote scheme comprising a plurality of sets of financing terms for the financial institutions, according to the business rules and rates of each financial institution.

14. The method of claim 13, wherein the portal participant comprises a representative selected from the group consisting of a motor vehicle dealer, a manufacturer, and a financial institution.

15. The method of claim 13, wherein the criteria is selected from the group consisting of make, model, year, series, body style, condition, additional features, and deducted features.

16. The method of claim 13, wherein step (a) further comprises receiving a vehicle identification number, the quotation generator checking the vehicle identification number against a database of known vehicle identification numbers to authenticate the transaction before proceeding to the next step.

17. The method of claim 13, wherein the business rules comprise rules on advances, rules on residuals and enhancements, terms for various model years, document requirements, and/or customer identification requirements.

18. The method of claim 13, wherein each set of financing terms is selected from the group consisting of a loan, a balloon loan, and a lease option.

19. The method of claim 13, wherein a rate comprises a lending rate associated with vehicle criteria according to a set of financing terms.

20. The method of claim 13, wherein the method further comprises calculating and displaying the taxes applicable to each set of financing terms.

21. The method of claim 20, wherein the method further comprises retrieving customer residence information into the transaction engine, the transaction engine querying a database of tax information corresponding to residence information, and the transaction engine calculating the taxes for each set of financing terms based on customer residence information.

22. The method of claim 13, wherein the method further comprises:
(e) receiving a selection of a set of financing terms from the comparative quote scheme into the transaction engine.

23. The method of claim 22, wherein the method further comprises:
(f) the transaction engine transmitting the selected set of financing terms to the selected financial institution;
(g) the transaction engine receiving and transmitting customer credit information to the selected financial institution as a credit application;
(h) the transaction engine receiving from the financial institution a signal indicating whether the financial institution has approved the credit application; and
(i) the transaction engine preparing financing documentation incorporating the criteria, the selected set of financing terms, and customer credit information.

24. The method of claim 23 wherein the documentation comprises a loan contract and a guaranteed value loan certification.

25. A system for processing a motor vehicle finance transaction online for a portal participant acting for a customer, the system comprising:
(a) a portal interface for receiving customer and vehicle information from a portal participant relating to a motor vehicle finance transaction;
(b) a processor in communication with the interface, executing software, the software comprising an online motor vehicle finance transaction engine for:
(i) querying at least one database of business rules and rates based on information received through the interface;
(ii) determining and displaying a comparative quote scheme for the motor vehicle finance transaction based on results of a query in step (i);
(iii) receiving a selection of a set of financing terms from the comparative quote scheme;
(iv) submitting a customer credit application to a financial institution on the basis of the selected set of financing terms and the information received through the interface; and
(v) upon receiving an approval of the credit application from the financial institution, preparing documentation incorporating the information received through the interface; and
(c) a computer storage in communication with the processor for storing the at least one database of business rules and rates, and the information received through the interface.

26. A software product contained on a computer-readable medium, the software comprising an online motor vehicle finance transaction engine for:
(a) querying at least one database of business rules and rates based on customer and vehicle information received through a portal interface;
(b) determining and displaying a comparative quote scheme based on results of a query in step (a);
(c) receiving a selection of a set of financing terms from the comparative quote scheme;
(d) submitting a credit application to a financial institution on the basis of the selected set of financing terms and the information received through the interface; and
(e) upon receiving an approval of the credit application from the financial institution, preparing documentation incorporating the information received through the interface.
